(19) United States
(12) Patent Application Publication
(10) Pub. No.: US 2026/0164492 A1
(43) Pub. Date: Jun. 11, 2026

(54) RADIO LINK FAILURE (RLF) AVOIDANCE

(71) Applicant: QUALCOMM Incorporated, San Diego, CA (US)

(72) Inventors: Ashutosh GUPTA, Gangapur City (IN); Ravi SHUKLA, Hyderabad, Telangana (IN); Harinath Reddy PATEL, Hyderabad, Telangana (IN)

(21) Appl. No.: 18/974,645

(22) Filed: Dec. 9, 2024

(51) Int. Cl. H04W 76/19; H04L 5/00; H04L 43/0823

(52) U.S. Cl. CPC H04W 76/19; H04L 5/0051; H04L 43/0823

(57) ABSTRACT

A wireless node may one or more memories, individually or in combination, having instructions. A wireless node may one or more processors, individually or in combination, configured to execute the instructions and cause the wireless node to: output, for transmission via a link, signaling comprising a first protocol data unit (PDU); and output, for transmission, a reference signal, the output being based on satisfaction of a first condition associated with a signal quality metric associated with the link.

### BACKGROUND

### Technical Field

The present disclosure generally relates to wireless communication systems, and more particularly, to mechanisms configured to reduce instances of radio link failure (RLF).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the disclosure are directed to an apparatus for wireless communication. In some examples, the apparatus includes one or more memories, individually or in combination, having instructions. In some examples, the apparatus includes one or more processors, individually or in combination, configured to execute the instructions. In some examples, the apparatus is configured to output, for transmission via a link, signaling comprising a first protocol data unit (PDU). In some examples, the apparatus is configured to output, for transmission, a reference signal, the output being based on satisfaction of a first condition associated with a signal quality metric associated with the link.

Aspects of the disclosure are directed to an apparatus for wireless communication. In some examples, the apparatus includes one or more memories, individually or in combination, having instructions. In some examples, the apparatus includes one or more processors, individually or in combination, configured to execute the instructions. In some examples, the apparatus is configured to output, for transmission, signaling comprising an indication of a first condition associated with a first retransmission counter. In some examples, the apparatus is configured to obtain, via a link, a reference signal indicative of satisfaction of the first condition. In some examples, the apparatus is configured to output, via the link and after the reference signal is obtained, signaling configured to initiate a handover process.

Aspects of the disclosure are directed to a method for wireless communication at a wireless node. In some examples, the method includes outputting, for transmission via a link, signaling comprising a first protocol data unit (PDU). In some examples, the method includes outputting, for transmission, a reference signal, the output being based on satisfaction of a first condition associated with a signal quality metric associated with the link.

Aspects of the disclosure are directed to a method for wireless communication at a wireless node. In some examples, the method includes outputting, for transmission, signaling comprising an indication of a first condition associated with a first retransmission counter. In some examples, the method includes obtaining, via a link, a reference signal indicative of satisfaction of the first condition. In some examples, the method includes outputting, via the link and after the reference signal is obtained, signaling configured to initiate a handover process.

Aspects of the disclosure are directed to an apparatus. In some examples, the apparatus includes means for outputting, for transmission via a link, signaling comprising a first protocol data unit (PDU). In some examples, the apparatus includes means for outputting, for transmission, a reference signal, the output being based on satisfaction of a first condition associated with a signal quality metric associated with the link.

Aspects of the disclosure are directed to an apparatus. In some examples, the apparatus includes means for outputting, for transmission, signaling comprising an indication of a first condition associated with a first retransmission counter. In some examples, the apparatus includes means for obtaining, via a link, a reference signal indicative of satisfaction of the first condition. In some examples, the apparatus includes means for outputting, via the link and after the reference signal is obtained, signaling configured to initiate a handover process.

Aspects of the disclosure are directed to a non-transitory computer-readable medium comprising instructions that, when executed by a wireless node, cause the wireless node to perform a method. In some examples, the method includes outputting, for transmission via a link, signaling comprising a first protocol data unit (PDU). In some examples, the method includes outputting, for transmission, a reference signal, the output being based on satisfaction of a first condition associated with a signal quality metric associated with the link.

Aspects of the disclosure are directed to a non-transitory computer-readable medium comprising instructions that, when executed by a wireless node, cause the wireless node to perform a method. In some examples, the method includes outputting, for transmission, signaling comprising an indication of a first condition associated with a first retransmission counter. In some examples, the method includes obtaining, via a link, a reference signal indicative of satisfaction of the first condition. In some examples, the method includes outputting, via the link and after the reference signal is obtained, signaling configured to initiate a handover process.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 illustrates an example of a process that supports triggering radio link control (RLC) radio link failure (RLF).

FIG. 6 is a call-flow diagram illustrating example communications between a transmitting RLF entity and a receiving RLF entity.

FIG. 7 is a call-flow diagram illustrating additional example communications between a transmitting RLF entity and a receiving RLF entity.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a flowchart of a method of wireless communication.

FIG. 13 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In some examples, a UE may be configured with control mechanism that allow the UE to trigger an RLF recovery procedure to request that a network reestablish a radio link with the UE if RLF is declared by the UE. For example, the UE may be configured with a network configured maximum retransmission threshold that determines or otherwise identifies the maximum number of retransmissions of a PDU that may occur before the UE triggers the RLF. During the multi-PDU transmission, the UE may determine that the maximum number of retransmissions have occurred for the one or more PDUs of the multi-PDU transmission without a corresponding feedback message being received (e.g., the UE may determine that the threshold number of instances of a poll bit being set to request the feedback message, without receiving such feedback messages in response, have been reached). Accordingly, the UE may initiate or otherwise trigger the RLF recovery procedure in response to the absence of corresponding feedback messages being received in relation to the UE configured accumulated retransmission threshold.

However, RLF recovery procedures may consume a significant amount of time, and may result in service outage. Thus, the mechanisms for early detection of poor uplink channel conditions and avoiding radio link failure (RLF) procedures described herein may improve communications by reducing service outages.

In some examples, the UE may determine that the uplink channel conditions have deteriorated if a count on a retransmission counter satisfies a threshold condition. It should be noted that the aforementioned “retransmission counter” for uplink channel conditions may be separate from retransmission counters associated with RLF, and in some examples, the threshold condition associated with the uplink channel conditions retransmission counter may be a fraction of a threshold condition associated with an RLF retransmission counter. As such, the UE may determine that an uplink channel condition has deteriorated, and may take steps to notify the network of poor channel condition prior to performing RLF procedures.

In certain aspects, the UE may transmit a reference signal (e.g., a dedicated sounding reference signal (SRS) or a non-legacy (e.g., sixth generation (6G)) beacon reference signal, either of which is configured for usage in poor uplink channel conditions) configured to notify the network of the poor uplink channel conditions detected via the retransmission counter. Although the UE may determine that uplink channel conditions have deteriorated, the reference signal (being a relatively low complexity signal) would have a relatively higher probability of being received by the network despite unfavorable uplink channel conditions.

In response to receiving the reference signal, the network may determine to initiate mitigation processes (e.g., a handover process and/or a beamforming process, etc.) to improve the uplink channel. In this manner, the UE may recover satisfactory uplink channel conditions relatively faster than performing RLF recovery procedures.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

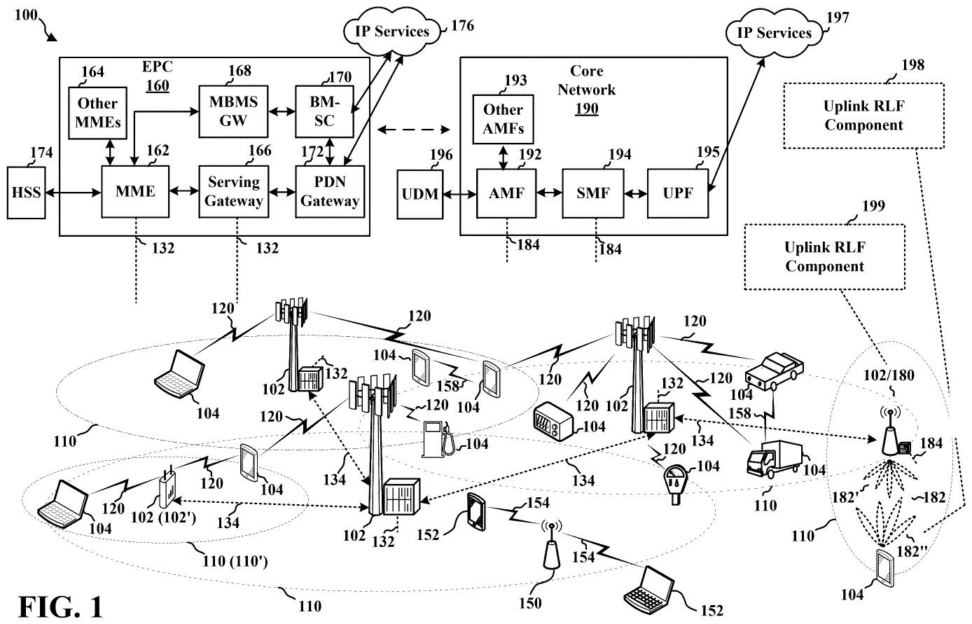

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include an uplink RLF component 198. As described in more detail elsewhere herein, the uplink RLF component 198 may be configured to: output, for transmission via a link, signaling comprising a first protocol data unit (PDU); and output, for transmission, a reference signal, the output being based on satisfaction of a first condition associated with a signal quality metric associated with the link. Additionally, or alternatively, the uplink RLF component 198 may perform one or more other operations described herein.

The base station 102/180 may include an uplink RLF component 199. As described in more detail elsewhere herein, the uplink RLF component 199 may be configured to: output, for transmission, signaling comprising an indication of a first condition associated with a first retransmission counter; obtain, via a link, a reference signal indicative of satisfaction of the first condition; and output, via the link and after the reference signal is obtained, signaling configured to initiate a handover process. Additionally, or alternatively, the uplink RLF component 199 may perform one or more other operations described herein.

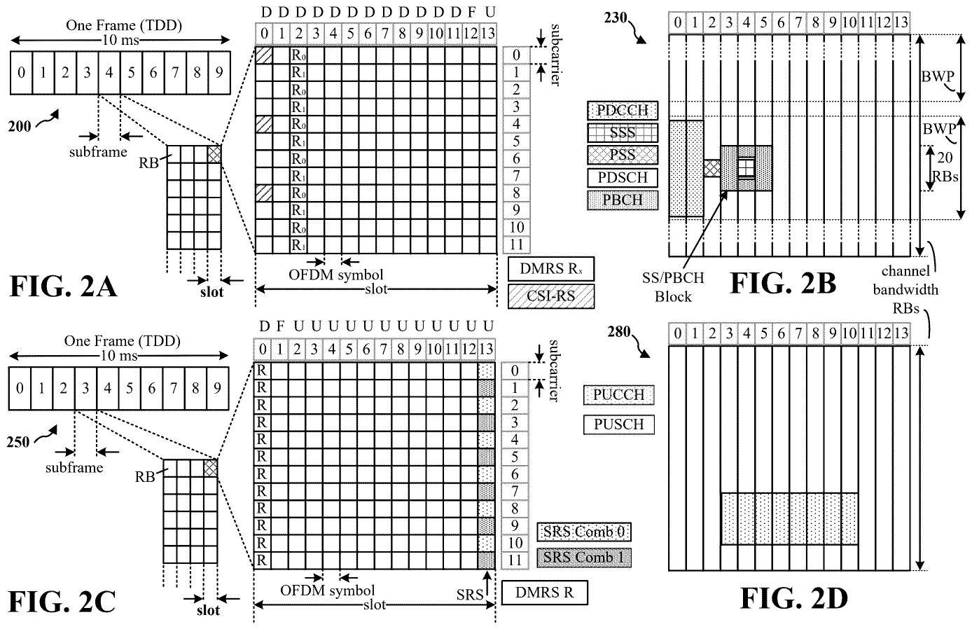

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

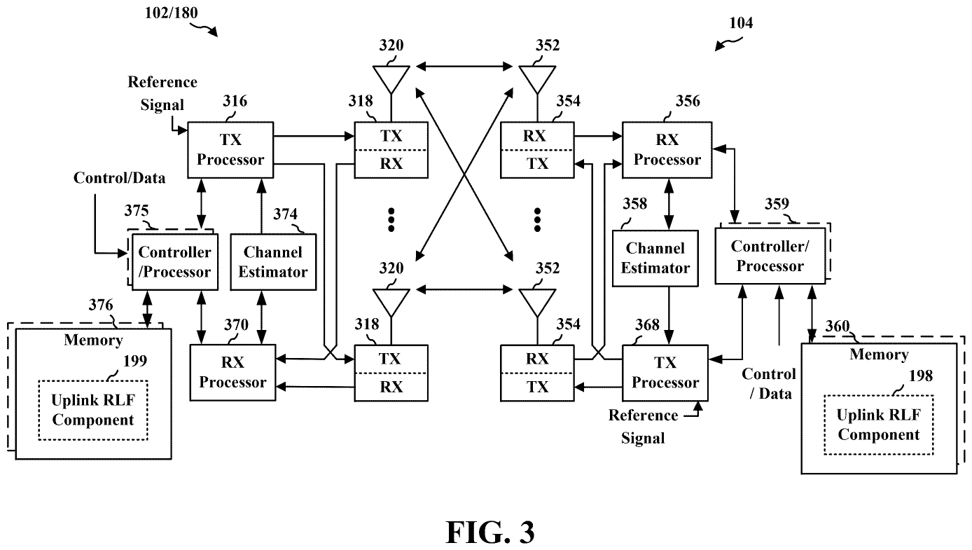

FIG. 3 is a block diagram of a base station 102/180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

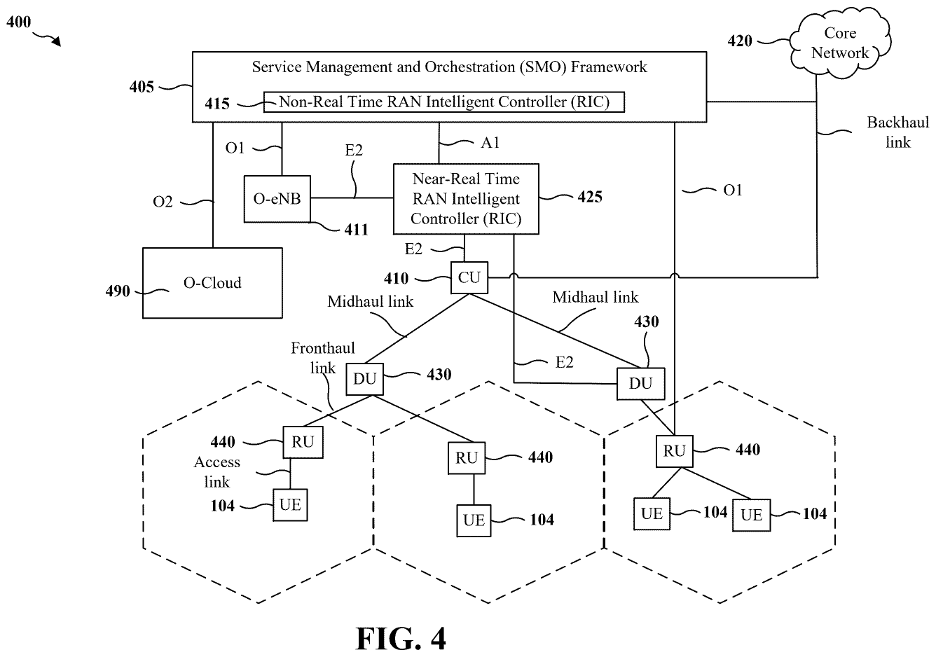

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of a Radio Link Control (RLC) Layer

In certain aspects, a UE in a connected state may communicate with a network entity using a radio protocol stack that includes packet data convergence protocol (PDCP), radio link control (RLC), medium access control (MAC) and physical (PHY) layers. One or more data radio bearers (DRBs) may be established between the UE and the network entity for exchanging user plane packets. Each DRB is associated with one PDCP entity, one or more RLC entities, and a logical channel in the MAC layer.

The main services and functions of the RLC layer include: transfer of PDUs, error correction through ARQ (only for acknowledged mode (AM) data transfer), concatenation, segmentation and reassembly of RLC SDUs (only for un-acknowledgement mode (UM) and AM data transfer), re-segmentation of the RLC data PDUs (only for the AM data transfer), reordering of the RLC data PDUs (only for the UM and AM data transfer), duplicate detection (only for the UM and AM data transfer), protocol error detection (only for the AM data transfer), the RLC SDU discard (only for the UM and AM data transfer), and RLC re-establishment.

Functions of the RLC layer are performed by the RLC entities. An RLC entity can be configured to perform the data transfer in one of the following three modes:
transparent mode (TM), unacknowledged mode (UM), and acknowledged mode (AM). Consequently, the RLC entity is categorized as a TM RLC entity, an UM RLC entity, or an AM RLC entity depending on the mode of data transfer that the RLC entity is configured to provide. The TM RLC entity is configured either as a transmitting TM RLC entity or a receiving TM RLC entity. The transmitting TM RLC entity receives RLC SDUs from an upper layer (e.g., PDCP) and sends RLC PDUs to its peer receiving the TM RLC entity via lower layers (e.g., MAC). The receiving TM RLC entity delivers the RLC SDUs to the upper layer (e.g., PDCP) and receives the RLC PDUs from its peer transmitting the TM RLC entity via the lower layers (e.g., MAC).

The UM RLC entity is configured either as a transmitting UM RLC entity or a receiving UM RLC entity. The transmitting UM RLC entity receives the RLC SDUs from the upper layer and sends the RLC PDUs to its peer receiving UM RLC entity via the lower layers. The receiving UM RLC entity delivers the RLC SDUs to the upper layer and receives the RLC PDUs from its peer transmitting the UM RLC entity via the lower layers. The AM RLC entity includes a transmitting side and a receiving side. The transmitting side of the AM RLC entity receives the RLC SDUs from the upper layer and sends the RLC PDUs to its peer AM RLC entity via the lower layers. The receiving side of the AM RLC entity delivers the RLC SDUs to the upper layer and receives the RLC PDUs from its peer AM RLC entity via the lower layers.

Due to the UE mobility, the UE may be handed over from one network entity to another network entity if radio link quality degrades to the point of failure or close to failure. For example, in dual connectivity (DC), due to UE mobility, the UE may handover from one network entity (e.g., a first master eNB (MeNB) or a first secondary eNB (SeNB)) to another network entity (e.g., a second MeNB or a second SeNB). A network entity may support multiple cells and the UE may also handover from one cell to another cell of same network entity.

In UM RLC, in-sequence delivery to higher layers is provided, but retransmissions of missing PDUs may not be requested. Accordingly, UM may be used for services such as VoIP where error-free delivery is of less importance compared to short delivery time. When a transmitting UM RLC entity forms UMD PDUs from RLC SDUs, the transmitting UM RLC entity may: i) segment and/or concatenate the RLC SDUs so that the UMD PDUs fit within the total size of RLC PDU(s) indicated by lower layer at the particular transmission opportunity notified by lower layer; and ii) include relevant RLC headers in the UMD PDU.

When a receiving UM RLC entity receives UMD PDUs, the receiving UM RLC entity may: i) detect whether or not the UMD PDUs have been received in duplication, and discard duplicated UMD PDUs; ii) reorder the UMD PDUs if they are received out of sequence; iii) detect the loss of UMD PDUs at lower layers and avoid excessive reordering delays; iv) reassemble RLC SDUs from the reordered UMD PDUs (not accounting for RLC PDUs for which losses have been detected) and deliver the RLC SDUs to upper layer in ascending order of the RLC SN; and v) discard received UMD PDUs that cannot be reassembled into a RLC SDU due to loss at lower layers of an UMD PDU which belonged to the particular RLC SDU.

In AM RLC, an AM RLC entity may provide a bidirectional data transfer service. Therefore, a single AM RLC entity may be configured to transmit and receive. Aspects of the AM RLC entity configured to transmit data may be referred to as a transmitting side while parts of the AM RLC entity configured to receive data may be referred to as a receiving side.

In contrast to a UM RLC entity, AM RLC entity may support retransmission of data to correct transmission errors. An ARQ operation may be performed to support error-free transmission. The AM RLC entity may be utilized by error-sensitive and delay-tolerant applications, such as interactive/background type services (e.g., web browsing and file downloading) and streaming-type services, for example.

In order that the transmitting side of the AM RLC entity retransmits missing RLC PDUs, the receiving side may provide a status report to the transmitting side indicating ACK and/or NACK information for the RLC PDUs. For example, the status report may be transmitted from a transmitting side of another AM RLC entity whose receiving side received corresponding RLC PDUs. Based on the status PDU, the transmitting side may perform a retransmission of a corresponding RLC PDU.

### Examples of Radio Link Failure (RLF) Prediction

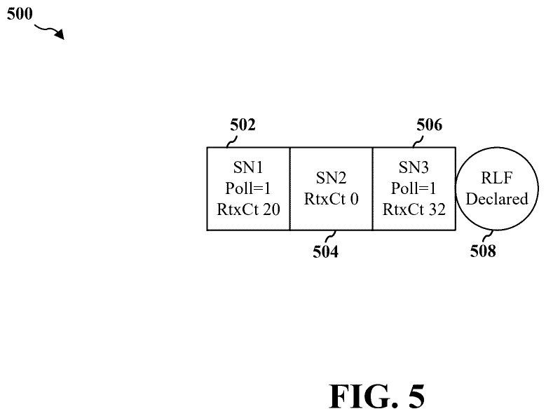

FIG. 5 illustrates an example of a process 500 that supports triggering RLC RLF. In some examples, the process 500 may be implemented by aspects of the access network 100. Specifically, aspects of the process 500 may be implemented by a UE 104 and/or network entity 102, which may be examples of the corresponding devices described herein.

Some wireless communication devices may support ARQ procedures being performed by an RLC acknowledgment mode (AM) entity, e.g., such as an RLC protocol layer implementing AM techniques. For example, the transmitting side of an AM RLC entity (e.g., a UE) may receive a NACK for an RLC SDU or an RLC SDU segment by a status report (e.g., a feedback message) PDU from its peer AM RLC entity (e.g., a network entity). For example, the AM RLC entity may set a poll bit in a PDU transmitted to the peer AM RLC entity. The poll bit may signal a request for the status report (e.g., feedback message) from the peer AM RLC entity for the PDU providing ACK/NACK information for the PDU. If the status report indicates NACK information, the transmitting AM RLC entity will then retransmit the PDU.

That is, in some wireless communication systems the transmitting AM RLC entity may include a poll or poll bit in an AM data (AMD) PDU to request its peer AM RLC entity to respond with a status report (e.g., a feedback message) if the poll PDU or poll bits meet certain thresholds, which are typically configured by the network. For example, a poll retransmit counter (e.g., RETX_Count) or timer (e.g., tPollRetransmit) may expire if the network entity does not send an ACK to the poll PDU. In this event, the transmitting side of the AM RLC entity may declare an RLF after the network configured maximum retransmission threshold (e.g., maxRetxThreshold) has been reached.

As discussed, the transmitting side of the AM RLC entity may include a poll bit in an AMD PDU. The transmitting AM RLC entity may not receive any status report from its peer AM RLC entity due to various reasons, e.g., channel conditions, collisions, etc. In the situation where there is continuous IP layer data being transmitted (e.g., a multi-PDU transmission), such as a ping or UDP data service, at the same time, the RLC will continue to transmit new AMD PDU and set the polling bit in the highest SN. This may result in the PDUs with the poll bit being set not being retransmitted since the new data continues to increment the polling bit to the highest SN.

Such a procedure may result in the RLC transmitting entity being unable to reach the network configured maximum retransmission threshold (e.g., maxRetxThreshold) even though there has not been any ACK received from the network entity. Given that the RLC window may be very large (e.g., AM window size equals 131072 for an 18-bit SN), this may take a very long time to trigger RLF, which may result in a data stall and negatively impact user experience.

In a multi-PDU transmission, the network configured maximum retransmission threshold (e.g., maxRetxThreshold) may be relatively large (e.g., 32). The UE (e.g., the transmitting side of an AM RLC entity) may send an RLC PDU to the network entity successfully with the polling bit being set to a value requesting a status report, but the network entity may not have sent the status report PDU to the UE. In this situation, the UE may continue to retransmit this PDU. Before the retransmissions reach the network configured maximum retransmission threshold, a higher layer may request the RLC to send a new PDU, thus the polling SN may be set to the new RLC PDU SN. This procedure might be repeated, which may mean that the UE RLC may never reach the network configured maximum retransmission threshold, and therefore the UE may not trigger RLF, and the data service may not be restored. That is, if there are continuous IP layer data transmissions, such as ping or UDP data service, at the same time (e.g., such as in a multi-PDU transmission), this may render the data service unusable for an extended time period.

FIG. 5 includes a depiction of multiple RLC layer PDUs for transmission by a first AM RLC entity. The multiple PDUs include a first PDU 502 having a serial number of 1(SN1 ). In this example, the first PDU 502 includes a poll bit set to 1, indicating a request for a status report from a second AM RLC entity in response to receiving the first PDU 502.

In this example, the first AM RLC entity does not receive a status report in response to transmission of the first PDU 502. For example, upon transmission of the first PDU 502, a poll timer may start. Upon expiration of the poll timer, if a status report has not been received, the first PDU 502 may be retransmitted. For each retransmission, a retransmission counter may be incremented. As illustrated, the first PDU 502 is retransmitted 20 times (e.g., RtxCt=20). However, the first AM RLC entity may be configured with a maximum retransmission threshold greater than 20 (e.g., 32). Thus, unless the first AM RLC entity may not be able to declare RLF until after 32 retransmissions.

In the example illustrated, a second PDU 504 (SN2) is queued for transmission prior to the retransmission count satisfying the threshold condition of 32 retransmissions. That is, because the second PDU 504 is ready for transmission, the first AM RLC entity stops retransmitting the first PDU 502 after 20 retransmissions, and proceeds to transmit the second PDU 504.

After transmission of the second PDU 504, the RLC entity may transmit a third PDU 506 (SN3) with a poll bit set to 1. In the example illustrated, the RLC entity retransmits the third PDU 506 32 times, thereby satisfying the threshold condition for declaring RLF 508.

It should be noted that FIG. 5 illustrates three PDUs for the sake of simplicity and explanation. In practice, there may be hundreds, thousands, or even more PDUs transmitted by an RLC entity prior to the retransmission threshold being met and RLF declared. Thus, one of the problems with this approach is that new PDUs may continue to be buffered for transmission without enough delay between each PDU to allow the retransmission threshold to be satisfied. Thus, for example, the uplink channel may be substantially degraded, but the RLC entity (e.g., UE) will be prevented from declaring RLF. Accordingly, the UE may continue transmitting via a degraded channel for an indefinite period of time before determining to declare RLF and initiating RLF recovery procedures.

However, RLF recovery procedures consume a significant amount of time, and may result in service outage. Thus, avoiding a declaration of RLF and the associated procedures may improve communications by reducing service outages.

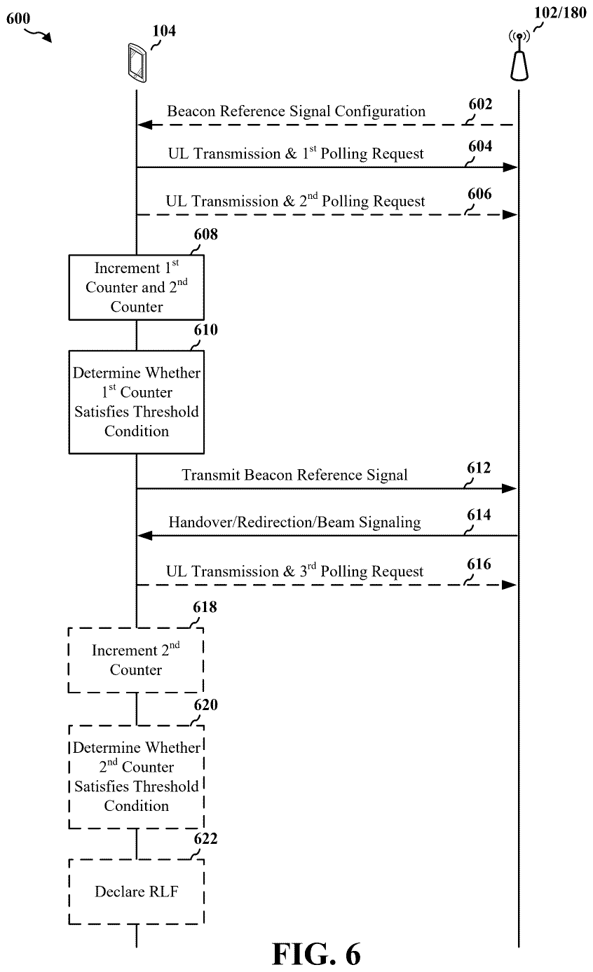

FIG. 6 is a call-flow diagram illustrating example communications between a transmitting RLF entity (e.g., UE 104) and a receiving RLF entity (e.g., network entity 102). In this example, the UE 104 may be configured as an RLC AM entity.

At a first communication 602, the network entity 102 may transmit a beacon reference signal configuration to the UE 104. The beacon reference signal configuration may include a particular pattern (e.g., time and/or frequency resources) via which the beacon reference signal is to be transmitted. The configuration may also indicate that the beacon reference signal is for transmission in response to a prediction/estimation of a future RLF. As such, transmission of the beacon reference signal may be used to indicate a poor uplink communication channel to the network entity 102. Thus, if the network entity 102 receives the beacon reference signal, it may respond by initiating a handover process, a redirection process, and/or a beam management process. The beacon reference signal may be configured as a relatively simply signal (e.g., as an SRS) to ensure a relatively high likelihood that the network entity 102 may receive the beacon reference signal even if the uplink channel is degraded or in a poor condition.

In some examples, the first communication 602 (or another communication, such as an RRC configuration message) may include an indication of a first retransmission counter threshold and a second retransmission counter threshold. The first retransmission counter threshold and the second retransmission counter thresholds are threshold values (e.g., non-zero integers) associated with a PDU retransmission counter. In some examples, the first retransmission counter threshold value (i.e., first value) may be a function of the second retransmission counter threshold value (i.e., second value). For example, if the second value is 32 (e.g., meaning 32 retransmissions of the same PDU), then the first value may be half that value (e.g., 16) or some other lesser value (e.g., any suitable number less than 16, including 1-15).

The function of the first retransmission counter threshold is provide the UE 104 with an triggering mechanism for transmitting the beacon reference signal, whereas the second retransmission counter threshold functions to provide the UE 104 with a triggering mechanism for declaring RLF. Thus, for example, referring back to FIG. 5, assume the second value is 32 (e.g., RtxCt =32) and the first value is 10. In this example, after the tenth retransmission of the first PDU 502 (e.g., when RxtCt=10), the UE 104 may begin transmitting the beacon reference signal. That is, satisfaction of the first retransmission counter threshold is satisfied when the number of retransmissions of the first PDU 502 equals the first value.

Alternatively, satisfaction of the first retransmission counter threshold is satisfied when the number of retransmissions of any PDU(s) equals the first value. In this example, if a first PDU is retransmitted 5 times, a second PDU is retransmitted 3 times, and a third PDU is retransmitted 2 times, then the first retransmission counter threshold may be satisfied because there has been a total of 10 PDU retransmissions.

In either case, if the network entity 102 does not respond to the beacon reference signal (e.g., the network entity 102 does not receive the signal), then the UE 104 may declare RLF when the second retransmission counter threshold is satisfied.

The network entity 102 may configure the UE 104 to transmit the beacon reference signal according to a periodic, semi static, or dynamic basis.

At a second communication 604, the UE 104 may transmit a first PDU to the network entity with a bit set to indicate a polling request. If the UE 104 does not receive and/or the network entity 102 does not transmit-a status report in response to the polling request, then at a first process 608, the UE 104 may increment each of the first retransmission counter (e.g., counter configured to trigger transmission of the beacon reference signal upon satisfaction of a corresponding threshold) and the second retransmission counter (e.g., counter configured to trigger declaration of RLF).

At an optional third communication 606, the UE 104 may transmit another RLC PDU with a bit set to indicate a polling request, or retransmit the PDU of the second communication 604 with the polling request bit set. Each time a PDU is (re)transmitted with a polling bit set and the polling timer expires, the UE 104 may increment each of the first retransmission counter and the second retransmission counter, as shown at the first process 608.

At a second process 610, the UE 104 may determine that the threshold condition of the first retransmission counter has been met (e.g., the number of PDU retransmissions without receiving a status report equals the first value, 10). As noted above, the satisfaction of the threshold condition associated with the first retransmission counter may occur prior to satisfaction of the threshold condition associated with the second retransmission counter. In other words, the beacon reference signal is transmitted prior to an RLF declaration. This is because transmitting the beacon reference signal to notify the network entity 102 of the poor condition of the uplink channel and triggering a remedial process may resolve uplink communications issues faster than an RLF process.

Accordingly, the UE (in a fourth communication 612) may transmit the beacon reference signal in response to satisfaction of the threshold condition associated with the first retransmission counter. As discussed, the beacon reference signal may be configured to indicate that the uplink channel is no longer satisfactory for communication, and the signal may be transmitted periodically.

At a fifth communication 614, the network entity 102 may signaling configured to remediate the uplink channel conditions. For example, the signaling may be configured to handover or redirect the UE to another cell or network entity, or may initiate a beam management procedure to find a beam that provides higher quality communication.

As noted, in some examples, the network entity 102 may not receive the beacon reference signal, and thus, may perform the fifth communication 614. In such a case, the UE 104 may continue to transmit uplink PDUs with polling requests (e.g., as shown in the optional sixth communication 616). At an optional third process 618, the UE may continue to increment the second retransmission counter with each PDU transmitted without receiving a status report from the network entity 102.

At an optional fourth process 620, the UE 104 may determine that the threshold condition of the second retransmission counter has been met (e.g., the number of PDU retransmissions without receiving a status report equals the second value, 32). In some examples, the threshold condition of the second retransmission counter is satisfied if the same PDU is retransmitted without triggering a status report 32 times. In another example, the 32 retransmissions may be a count of retransmissions of multiple different PDUs.

At an optional fifth process 622, the UE may declare RLF based on the second counter satisfying the associated threshold condition.

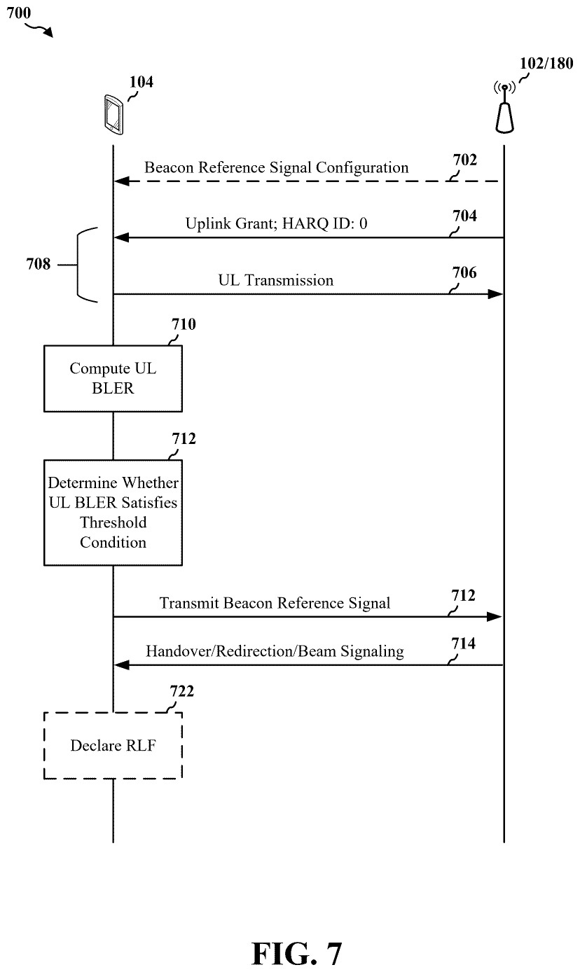

FIG. 7 is a call-flow diagram illustrating additional example communications between a transmitting RLF entity (e.g., UE 104) and a receiving RLF entity (e.g., network entity 102). In this example, the UE 104 may be configured as an RLC UM entity.

At an optional first communication 702, the network entity 102 may transmit a beacon reference signal configuration to the UE. The beacon reference signal configuration may include some or all of the information provided in the beacon reference signal configuration described above in reference to FIG. 6. However, in some examples, the beacon reference signal configuration may also include an indication of a duration of time and/or a threshold value. In some examples, the threshold value may include a ratio, a percentage, or any other suitable numbering format associated with a block error rate or another signal quality metric. In some examples, the duration of time may be on the order of milliseconds (ms), e.g., 10-20 ms.

At a second communication 704, the network entity 102 may transmit an uplink grant to the UE 104, providing the UE 104 with information necessary to transmit an uplink PDU to the network entity 102. In some examples, the uplink grant may include a HARQ identifier value (e.g., 0) and a redundance version (RV) index value (e.g., 0).

At a third communication 706, the UE 104, in response to the uplink grant, may transmit the PDU to the network entity 102 via a link. However, due to poor link quality or other environmental issues, the network entity 102 may not receive or properly decode the uplink PDU. As illustrated, the second communication 704 and the third communication 706 are part of a communication block 708. Although FIG. 7 illustrates a single communication block 708, multiple instances of the same or similar communications may occur so that the UE 104 is capable of computing a BLER.

In one example, the communication block 708 may include communications made via the PHY/MAC layer. If link conditions are poor for uplink communications, the UE 104 may compute a BLER based on one of more instances of the communication block 708. For example, the network entity 102 may provide an uplink grant with HARD ID 0 and with RV index 0 (e.g., second communication 704). In response, the UE 104 may transmit PUSCH with HARQ ID 0 and RV 0 (e.g., third communication 706). However, the network entity 102 may fail to receive the PUSCH or decode the PUSCH. Because the network entity 102 did not receive the PUSCH, it may transmit another uplink grant with HARD ID 0 and with RV index 2 (e.g., another instance of the second communication 704). The UE may again transmit the PUSCH, with HARQ ID 0 and RV 2 (e.g., another instance of the third communication 706). Again, the network entity 102 may fail to receive it or decode it. Based on the number of retransmission grants received by the UE 104 having the same HARQ ID and/or a same NDI bit associated with a retransmission grant, the UE 104 may compute an uplink BLER. Based on this BLER, the UE 104 may declare RLF for RLC uplink bearers.

As such, at a first process 710, the UE 104 may compute an uplink BLER based on the number of retransmission grants received by the UE 104 having the same HARQ ID and/or a same NDI bit associated with a retransmission grant. In one example, the UE 104 may compute the uplink BLER based on the number of retransmission grants it received within a particular window of time. The time window and duration of the window may be configured by the beacon reference signal configuration, RRC configuration message, or MAC CE from the network entity 102. In this example, if the computed BLER is greater than or equal to a threshold value (e.g., also configured by the beacon reference signal configuration, RRC configuration message, or MAC CE from the network entity 102), the UE 104 may proceed to a second process 712 where it determines that the uplink BLER satisfies a threshold condition.

In response to satisfaction of the threshold condition, the UE 104 may transmit the beacon reference signal configured via the first communication 702. As discussed above in reference to FIG. 6, the beacon reference signal may be used to notify the network entity 102 that uplink communication quality has been reduced to the point that, if no action is taken, may lead to declaration of RLF by the UE 104.

If the network entity 102 receives the beacon reference signal, it may then perform any suitable process to remedy the poor uplink quality of the link, including: handover, beam management and/or redirection, etc. By doing this, the UE 104 may avoid declaring RLF and save time (e.g., the UE 104 no longer needs to rely on a retransmission counter such as RtxCt discussed in connection with FIG. 5, which can cause latency due to new data resetting the counter; nor does the UE 104 need to declare RLF which can cause further latencies). If the network entity 102 does not receive the beacon reference signal, the UE may optionally perform a third process 722 by declaring RLF.

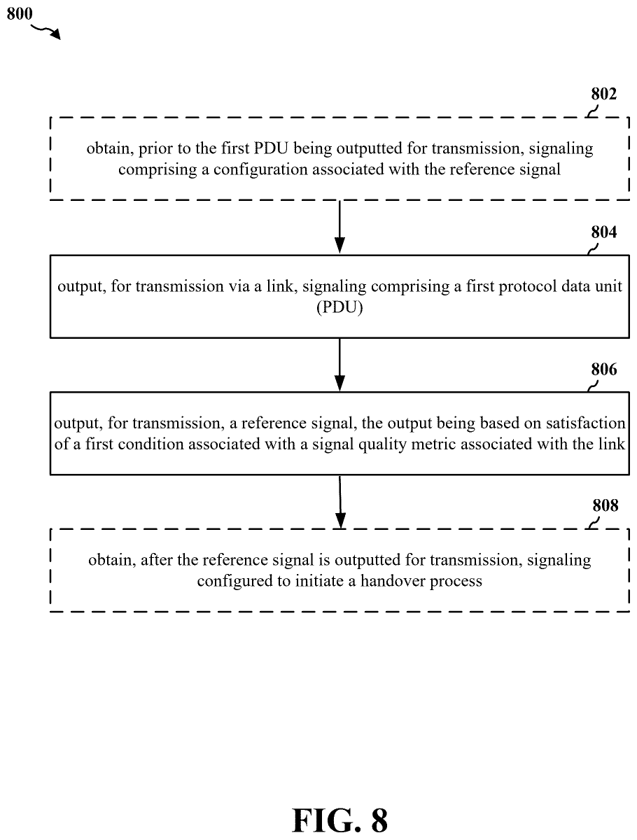

FIG. 8 is a flowchart 800 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3).

At 802, the UE may optionally obtain, prior to the first PDU being outputted for transmission, signaling comprising a configuration associated with the reference signal. For example, 802 may be performed by an obtaining component 1140. Here, a network entity may transmit signaling to configure the UE with an indication of a sounding reference signal (SRS) and/or a beacon signal to be used upon satisfaction of the first condition. In some examples, the beacon signal is a non-legacy (e.g., sixth generation (6G) cellular technology and later) reference signal. The configuration may also an indication of the first condition (e.g., a threshold value associated with a counter or a BLER ratio) of the link, wherein satisfaction of the first condition is indicative of a quality condition of the link.

At 804, the UE may output, for transmission via a link, signaling comprising a first protocol data unit (PDU). For example, 804 may be performed by an outputting component 1142. Here, the UE may transmit, via an uplink channel, a first PDU from the RLC-layer. That is, the first PDU may be outputted via an RLC-layer associated with the UE.

At 806, the UE may output, for transmission, a reference signal, the output being based on satisfaction of a first condition associated with a signal quality metric associated with the link. For example, 806 may be performed by the outputting component 1142. Here, the UE may transmit the SRS or beacon signal to be used upon satisfaction of the first condition. As discussed above, the SRS or beacon signal may be configured by the signaling comprising the configuration in reference to 802 above. The pattern or resources used for the SRS or beacon signal may be unique to indicate that signal is configured to indicate a quality-related failure of the uplink channel.

At 808, the UE may obtain, after the reference signal is outputted for transmission, signaling configured to initiate a handover process. For example, 808 may be performed by the obtaining component 1140. Here, the network entity, upon receiving the reference signal transmitted at 806 may determine that the uplink channel used by the UE is in a low-quality state for uplink communications. Thus, the network entity may initiate a remediation process (e.g., handover process) prior to a declaration of RLF by the UE. By performing such a process prior to the declaration of RLF, communication latency at the UE is reduced by avoiding time-consuming RLF processes.

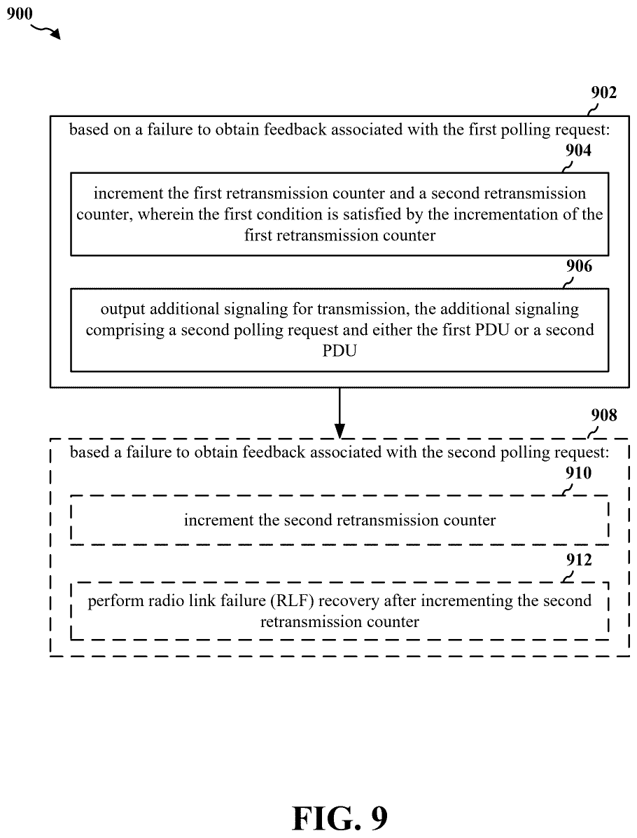

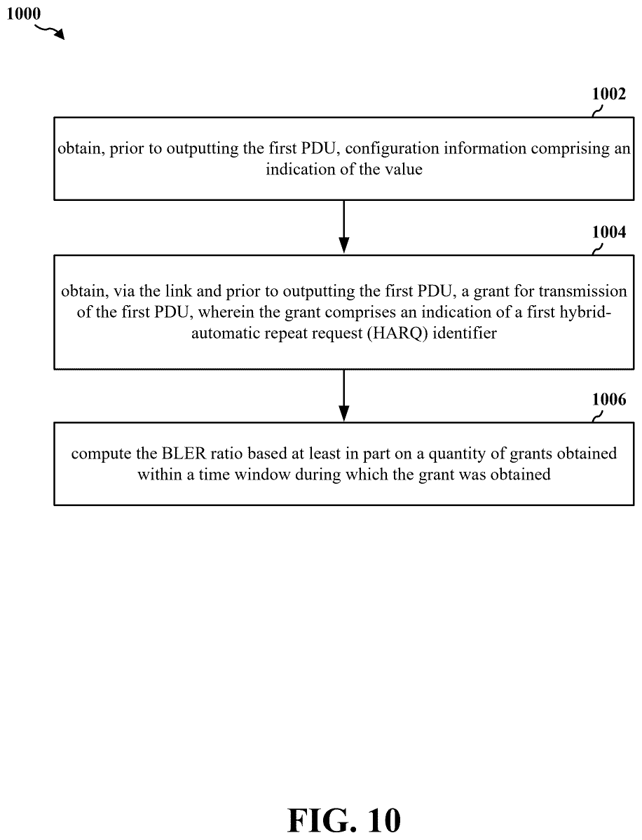

FIG. 9 is a flowchart 900 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3). In certain aspects, one or more features described in association with the method illustrated in FIG. 9 may be used by a UE in conjunction with one or more other features associated with the methods illustrated in one or more of FIGS. 8 and 10. In certain aspects, the method illustrated in FIG. 9 may include features used by a UE configured as an RLC AM bearer.

At 904, the UE may increment the first retransmission counter and a second retransmission counter, wherein the first condition is satisfied by the incrementation of the first retransmission counter. For example, 904 may be performed by an incrementing component 1144. Here, the first retransmission counter corresponds to a counter configured to trigger transmission of the beacon reference signal or the SRS signal when the counter reaches a threshold value.

At 906, the UE may output additional signaling for transmission, the additional signaling comprising a second polling request and either the first PDU or a second PDU. For example, 906 may be performed by the outputting component 1142. Here, the UE may continue to transmit the first PDU or transmit a second PDU based on a failure to obtain feedback associated with the first polling request. For example, 904 and 906 may be performed by the UE at 902 based on a failure to obtain feedback associated with the first polling request.

At 910, the UE may increment the first retransmission counter and a second retransmission counter, wherein the first condition is satisfied by the incrementation of the first retransmission counter. For example, 910 may be performed by the incrementing component 1144. At 912, the UE may increment the first retransmission counter and a second retransmission counter, wherein the first condition is satisfied by the incrementation of the first retransmission counter. For example, 912 may be performed by an RLF recovery component 1146. For example, 910 and 912 may be performed by the UE at 908 based a failure to obtain feedback associated with the second polling request.

In certain aspects, the signaling further comprises a first polling request associated with the first PDU, and the signal quality metric is associated with a first retransmission counter.

In certain aspects, the first threshold condition is associated with a lower threshold relative to the second threshold condition.

In certain aspects, the signal quality metric of the link is associated with a physical (PHY) layer metric or a medium access control (MAC) layer metric.

FIG. 10 is a flowchart 1000 of a method of wireless communication. The method may be performed by a UE (e.g., the UE 104; the apparatus 1102). Specifically, the method may be performed by one or more memories, processors, and RF front ends (e.g., the memory 360, controller/processor 359, transmitter 354TX, receiver 354RX, antenna 352, etc. of FIG. 3). In certain aspects, one or more features described in association with the method illustrated in FIG. 10 may be used by a UE in conjunction with one or more other features associated with the methods illustrated in one or more of FIGS. 8 and 9. In certain aspects, the method illustrated in FIG. 10 may include features used by a UE configured as an RLC UM bearer.

At 1002, the UE may obtain, prior to outputting the first PDU, configuration information comprising an indication of the value. For example, 1002 may be performed by an obtaining component 1140. Here, the network entity may configure the UE with a value corresponding to a BLER ratio. The first condition is satisfied when the BLER ratio is equal to or greater than the value. In this case, the signal quality metric of the link comprises a BLER ratio.

At 1004, the UE may obtain, via the link and prior to outputting the first PDU, a grant for transmission of the first PDU, wherein the grant comprises an indication of a first hybrid-automatic repeat request (HARQ) identifier. For example, 1004 may be performed by the obtaining component 1140. Here, the grant for transmission of the first PDU may be a grant for re-transmission of the first PDU, and the grant may include the same HARD identifier value as a previous grant for the first PDU. Thus, indicating to the UE that the grant for transmission is a grant for re-transmission, and further indicating relatively poor quality of the uplink channel used for the transmission.

At 1006, the UE may compute the BLER ratio based at least in part on a quantity of grants obtained within a time window during which the grant was obtained. For example, 1006 may be performed by the computing component 1148.

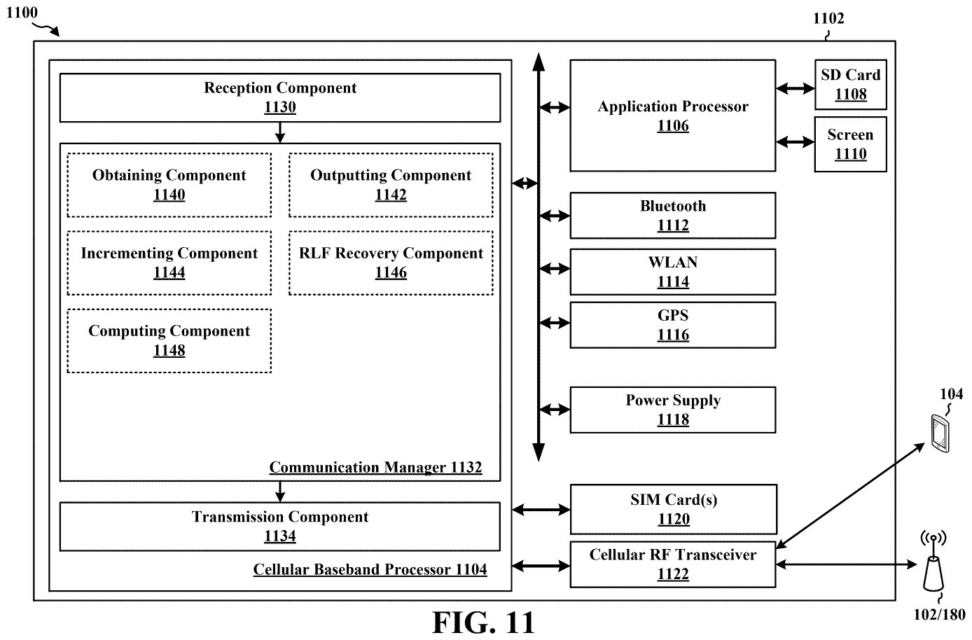

FIG. 11 is a diagram 1100 illustrating an example of a hardware implementation for an apparatus 1102. The apparatus 1102 is a UE and includes a cellular baseband processor 1104 (also referred to as a modem) coupled to one or more cellular RF transceivers 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the one or more cellular RF transceivers 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium / memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 104 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see UE 104 of FIG. 3) and include the aforediscussed additional modules of the apparatus 1102.

In various examples, the apparatus 1102 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1132 includes an obtaining component 1140 that is configured to: obtain, prior to the first PDU being outputted for transmission, signaling comprising a configuration associated with the reference signal; obtain, after the reference signal is outputted for transmission, signaling configured to initiate a handover process; obtain, prior to outputting the first PDU, configuration information comprising an indication of the value; and obtain, via the link and prior to outputting the first PDU, a grant for transmission of the first PDU, wherein the grant comprises an indication of a first hybrid-automatic repeat request (HARQ) identifier; e.g., as described in connection with 802, 808, 1002, and 1004.

The communication manager 1132 further includes an outputting component 1142 configured to: output, for transmission via a link, signaling comprising a first protocol data unit (PDU); output, for transmission, a reference signal, the output being based on satisfaction of a first condition associated with a signal quality metric associated with the link; and output additional signaling for transmission, the additional signaling comprising a second polling request and either the first PDU or a second PDU; e.g., as described in connection with 804, 806, and 906.

The communication manager 1132 further includes an incrementing component 1144 configured to: increment the first retransmission counter and a second retransmission counter, wherein the first condition is satisfied by the incrementation of the first retransmission counter; and increment the second retransmission counter; e.g., as described in connection with 904 and 910.

The communication manager 1132 further includes an RLF recovery component 1146 configured to perform radio link failure (RLF) recovery after incrementing the second retransmission counter; e.g., as described in connection with 912.

The communication manager 1132 further includes a computing component 1148 configured to compute the BLER ratio based at least in part on a quantity of grants obtained within a time window during which the grant was obtained, e.g., as described in connection with 1006.

The apparatus may include additional components that perform each of the blocks of the algorithm in the aforementioned flowcharts of FIGS. 8-10. As such, each block in the aforementioned flowcharts of FIGS. 8-10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes: means for obtaining, prior to the first PDU being outputted for transmission, signaling comprising a configuration associated with the reference signal; means for outputting, for transmission via a link, signaling comprising a first protocol data unit (PDU); means for outputting, for transmission, a reference signal, the output being based on satisfaction of a first condition associated with a signal quality metric associated with the link; means for obtaining, after the reference signal is outputted for transmission, signaling configured to initiate a handover process; means for incrementing the first retransmission counter and a second retransmission counter, wherein the first condition is satisfied by the incrementation of the first retransmission counter; means for outputting additional signaling for transmission, the additional signaling comprising a second polling request and either the first PDU or a second PDU; means for incrementing the second retransmission counter; means for performing radio link failure (RLF) recovery after incrementing the second retransmission counter; means for obtaining, prior to outputting the first PDU, configuration information comprising an indication of the value; means for obtaining, via the link and prior to outputting the first PDU, a grant for transmission of the first PDU, wherein the grant comprises an indication of a first hybrid-automatic repeat request (HARQ) identifier; and means for computing the BLER ratio based at least in part on a quantity of grants obtained within a time window during which the grant was obtained.

The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

For example, means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3. Means for incrementing, means for performing RLF recovery, and means for computing may include a processing system, which may include one or more processors, such as the controller/processor 359, the memory or memories 360, and/or any other suitable hardware components of the UE 104 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

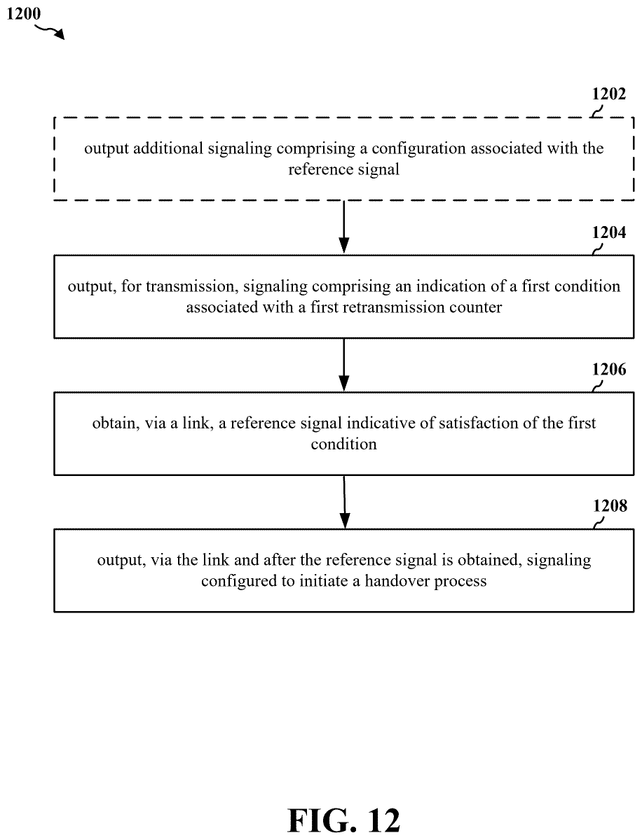

FIG. 12 is a flowchart 1200 of a method of wireless communication. The method may be performed by a network entity or base station (e.g., the base station 102/180; the apparatus 1302. Specifically, the method may be performed by one or more memories, processors, and RF front ends (e.g., the memory 376, controller/processor 375, transmitter 318TX, receiver 318RX, antenna 320, etc. of FIG. 3).

At 1202, the network entity may optionally output additional signaling comprising a configuration associated with the reference signal. For example, 1202 may be performed by an outputting component 1340.

At 1204, the network entity may output, for transmission, signaling comprising an indication of a first condition associated with a first retransmission counter. For example, 1204 may be performed by the outputting component 1340.

At 1206, the network entity may obtain, via a link, a reference signal indicative of satisfaction of the first condition. For example, 1206 may be performed by an obtaining component 1324.

Finally, at 1208, the network entity may output, via the link and after the reference signal is obtained, signaling configured to initiate a handover process. For example, 1208 may be performed by the outputting component 1340.

In certain aspects, the signaling further comprises an indication of a second condition associated with a second retransmission counter.

In certain aspects, satisfaction of the first condition is configured to cause a wireless node to transmit the reference signal.

In certain aspects, satisfaction of the second condition is configured to cause the wireless node to perform radio link failure (RLF) recovery.

In certain aspects, the first condition is associated with a first threshold that is lower than a second threshold associated with the second condition.

In certain aspects, the configuration associated with the reference signal comprises an indication of a sounding reference signal (SRS) to be used upon satisfaction of the first condition.

In certain aspects, the indication of the first condition comprises and indication of at least one of: (i) a value of the first retransmission counter associated with whether the first condition is satisfied, or (ii) a block error rate (BLER) value associated with whether the first condition is satisfied.

In certain aspects, the reference signal comprises a beacon signal or a sounding reference signal (SRS).

In certain aspects, the beacon signal is a non-legacy reference signal.

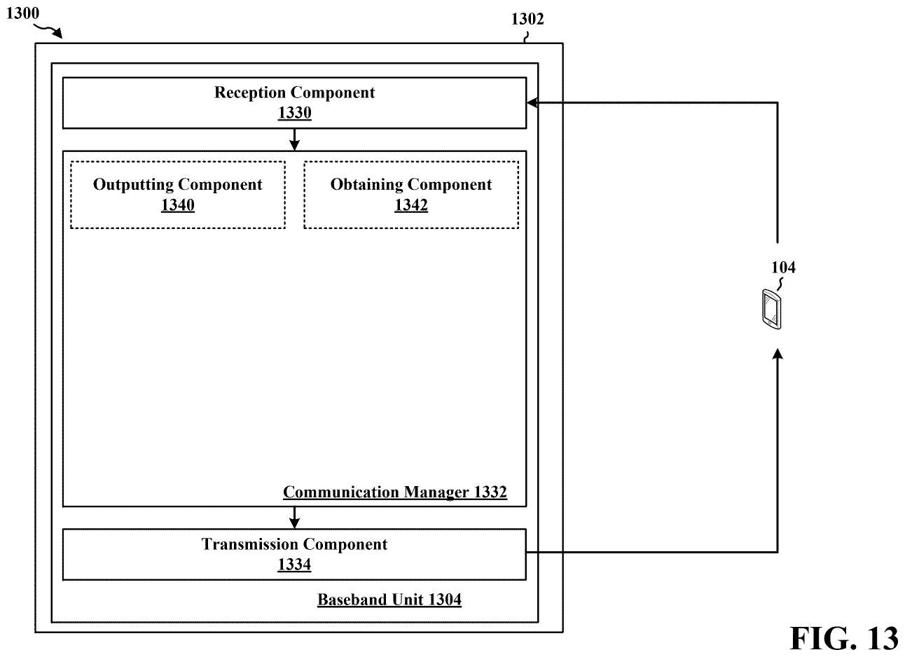

FIG. 13 is a diagram 1300 illustrating an example of a hardware implementation for an apparatus 1302. The apparatus 1302 is a BS or network entity, and includes a baseband unit 1304. The baseband unit 1304 may communicate through one or more cellular RF transceivers with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the BS 102/180 and may include the memory 376 and/or at least one of the TX processor 316, the RX processor 370, and the controller/processor 375.

In various examples, the apparatus 1302 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1332 includes an outputting component 1340 configured to: output additional signaling comprising a configuration associated with the reference signal; output, for transmission, signaling comprising an indication of a first condition associated with a first retransmission counter; and output, via the link and after the reference signal is obtained, signaling configured to initiate a handover process; e.g., as described in connection with 1202, 1204, and 1208.

The communication manager 1332 further includes an obtaining component 1342 configured to obtain, via a link, a reference signal indicative of satisfaction of the first condition, e.g., as described in connection with 1206.

The apparatus may include additional components that perform each of the blocks of the algorithm in the aforementioned flowchart of FIG. 12. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1302, and in particular the baseband unit 1304, includes: means for outputting additional signaling comprising a configuration associated with the reference signal; means for outputting, for transmission, signaling comprising an indication of a first condition associated with a first retransmission counter; means for obtaining, via a link, a reference signal indicative of satisfaction of the first condition; and means for outputting, via the link and after the reference signal is obtained, signaling configured to initiate a handover process.

The aforementioned means may be one or more of the aforementioned components of the apparatus 1302 configured to perform the functions recited by the aforementioned means. As described supra, the apparatus 1302 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

For example, means for receiving or means for obtaining may include a receiver, such as the receive processor 370 and/or antenna(s) 320 of the network entity 102/180 illustrated in FIG. 3. Means for transmitting or means for outputting may include a transmitter such as the transmit processor 316 or antenna(s) 320 of the network entity 102/180 illustrated in FIG. 3.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

Example 1 is a method for wireless communication at a wireless node, comprising: outputting, for transmission via a link, signaling comprising a first protocol data unit (PDU); and outputting, for transmission, a reference signal, the output being based on satisfaction of a first condition associated with a signal quality metric associated with the link.

Example 2 is the method of Example 1 further comprising obtaining, prior to the first PDU being outputted for transmission, signaling comprising a configuration associated with the reference signal.

Example 3 is the method of Example 2, wherein the configuration associated with the reference signal comprises an indication of a sounding reference signal (SRS) to be used upon satisfaction of the first condition.

Example 4 is the method of Example 1, wherein the satisfaction of the first condition is indicative of a quality condition of the link.

Example 5 is the method of any of Examples 1-4, wherein the reference signal comprises a beacon signal or a sounding reference signal (SRS).

Example 6 is the method of Example 5, wherein the beacon signal is a non-legacy reference signal.

Example 7 is the method of any of Examples 1-6, further comprising: obtaining, after the reference signal is outputted for transmission, signaling configured to initiate a handover process.

Example 8 is the method of any of Examples 1-7, wherein the first PDU is outputted via a radio link control (RLC) layer associated with the apparatus.

Example 9 is the method of any of Examples 1-8, wherein the signaling further comprises a first polling request associated with the first PDU, wherein the signal quality metric is associated with a first retransmission counter, and wherein the method further comprises, based on a failure to obtain feedback associated with the first polling request: incrementing the first retransmission counter and a second retransmission counter, wherein the first condition is satisfied by the incrementation of the first retransmission counter; and outputting additional signaling for transmission, the additional signaling comprising a second polling request and either the first PDU or a second PDU.

Example 10 is the method of Example 9, further comprising, based a failure to obtain feedback associated with the second polling request: incrementing the second retransmission counter; and performing radio link failure (RLF) recovery after incrementing the second retransmission counter.

Example 11 is the method of Example 10, wherein the first condition is associated with a first threshold that is lower than a second threshold associated with the second condition.

Example 12 is the method of any of Examples 1-11, wherein the signal quality metric of the link is associated with a physical (PHY) layer metric or a medium access control (MAC) layer metric.

Example 13 is the method of any of Examples 1-12, wherein the signal quality metric of the link comprises a block error rate (BLER) ratio.

Example 14 is the method of Example 13, further comprising: obtaining, via the link and prior to outputting the first PDU, a grant for transmission of the first PDU, wherein the grant comprises an indication of a first hybrid-automatic repeat request (HARQ) identifier; and computing the BLER ratio based at least in part on a quantity of grants obtained within a time window during which the grant was obtained.

Example 15 is the method of Example 14, wherein the first condition is satisfied when the BLER ratio is equal to or greater than a value.

Example 16 is the method of Example 15, further comprising: obtaining, prior to outputting the first PDU, configuration information comprising an indication of the value.

Example 17 is a method for wireless communication at a wireless node, comprising: outputting, for transmission, signaling comprising an indication of a first condition associated with a first retransmission counter; obtaining, via a link, a reference signal indicative of satisfaction of the first condition; and outputting, via the link and after the reference signal is obtained, signaling configured to initiate a handover process.

Example 18 is the method of Example 17, wherein the signaling further comprises an indication of a second condition associated with a second retransmission counter.

Example 19 is the method of Example 18, wherein at least one of: satisfaction of the first condition is configured to cause a wireless node to transmit the reference signal, satisfaction of the second condition is configured to cause the wireless node to perform radio link failure (RLF) recovery, or the first condition is associated with a first threshold that is lower than a second threshold associated with the second condition.

Example 20 is the method of any of Examples 17-19, further comprising: outputting additional signaling comprising a configuration associated with the reference signal.

Example 21 is the method of Example 20, wherein the configuration associated with the reference signal comprises an indication of a sounding reference signal (SRS) to be used upon satisfaction of the first condition.

Example 22 is the method of any of Examples 17-21, wherein the indication of the first condition comprises and indication of at least one of: (i) a value of the first retransmission counter associated with whether the first condition is satisfied, or (ii) a block error rate (BLER) value associated with whether the first condition is satisfied.

Example 23 is the method of any of Examples 17-22, wherein the reference signal comprises a beacon signal or a sounding reference signal (SRS).

Example 24 is the method of Example 23, wherein the beacon signal is a non-legacy reference signal.

Example 25 is an apparatus for wireless communications, comprising means for performing a method in accordance with any one of examples 1-16.

Example 26 is an apparatus for wireless communications, comprising means for performing a method in accordance with any one of examples 17-24.

Example 27 is a non-transitory computer-readable medium comprising instructions that, when executed by a wireless node, cause the wireless node to perform a method in accordance with any one of examples 1-16.

Example 28 is a non-transitory computer-readable medium comprising instructions that, when executed by a wireless node, cause the wireless node to perform a method in accordance with any one of examples 17-24.

Example 29 is an apparatus for wireless communications, comprising: one or more memories, individually or in combination, having instructions; and one or more processors, individually or in combination, configured to execute the instructions and cause the apparatus to perform a method in accordance with any one of examples 1-16.

Example 30 is an apparatus for wireless communications, comprising: one or more memories, individually or in combination, having instructions; and one or more processors, individually or in combination, configured to execute the instructions and cause the apparatus to perform a method in accordance with any one of examples 17-24.

Example 31 is a wireless node (e.g., UE), comprising: one or more transceivers; one or more memories, individually or in combination, having instructions; and one or more processors, individually or in combination, configured to execute the instructions and cause the wireless node to perform a method in accordance with any one of examples 1-16, wherein the one or more transceivers are configured to: transmit the signaling comprising the first PDU; and transmit the reference signal.

Example 32 is a wireless node (e.g., a network entity), comprising: one or more transceivers; one or more memories, individually or in combination, having instructions; and one or more processors, individually or in combination, configured to execute the instructions and cause the wireless node to perform a method in accordance with any one of examples 17-24, wherein the one or more transceivers are configured to: transmit the indication of the first condition; receive the reference signal; and transmit the signaling configured to initiate a handover process.

What is claimed is:

1. An apparatus for wireless communication, comprising:
one or more memories, individually or in combination, having instructions; and
one or more processors, individually or in combination, configured to execute the instructions and cause the apparatus to:
output, for transmission via a link, signaling comprising a first protocol data unit (PDU); and
output, for transmission, a reference signal, the output being based on satisfaction of a first condition associated with a signal quality metric associated with the link.

2. The apparatus of claim 1, wherein one or more processors, individually or in combination, are further configured to cause the apparatus to:
obtain, prior to the first PDU being outputted for transmission, signaling comprising a configuration associated with the reference signal.

3. The apparatus of claim 2, wherein the configuration associated with the reference signal comprises an indication of a sounding reference signal (SRS) to be used upon satisfaction of the first condition.

4. The apparatus of claim 1, wherein the satisfaction of the first condition is indicative of a quality condition of the link.

5. The apparatus of claim 1, wherein the reference signal comprises a beacon signal or a sounding reference signal (SRS).

6. The apparatus of claim 5, wherein the beacon signal is a non-legacy reference signal.

7. The apparatus of claim 1, wherein one or more processors, individually or in combination, are further configured to cause the apparatus to:
obtain, after the reference signal is outputted for transmission, signaling configured to initiate a handover process.

8. The apparatus of claim 1, wherein the first PDU is outputted via a radio link control (RLC) layer associated with the apparatus.

9. The apparatus of claim 1, wherein the signaling further comprises a first polling request associated with the first PDU, wherein the signal quality metric is associated with a first retransmission counter, and wherein the one or more processors, individually or in combination, are further configured to cause the apparatus to:
based on a failure to obtain feedback associated with the first polling request:
increment the first retransmission counter and a second retransmission counter, wherein the first condition is satisfied by the incrementation of the first retransmission counter; and
output additional signaling for transmission, the additional signaling comprising a second polling request and either the first PDU or a second PDU.

10. The apparatus of claim 9, wherein one or more processors, individually or in combination, are further configured to cause the apparatus to:
based a failure to obtain feedback associated with the second polling request:
increment the second retransmission counter; and
perform radio link failure (RLF) recovery after incrementing the second retransmission counter.

11. The apparatus of claim 10, wherein the first condition is associated with a first threshold that is lower than a second threshold associated with the second condition.

12. The apparatus of claim 1, wherein the signal quality metric of the link is associated with a physical (PHY) layer metric or a medium access control (MAC) layer metric.

13. The apparatus of claim 1, wherein the signal quality metric of the link comprises a block error rate (BLER) ratio.

14. The apparatus of claim 13, wherein the one or more processors, individually or in combination, are further configured to cause the apparatus to:
obtain, via the link and prior to outputting the first PDU, a grant for transmission of the first PDU, wherein the grant comprises an indication of a first hybrid-automatic repeat request (HARQ) identifier; and
compute the BLER ratio based at least in part on a quantity of grants obtained within a time window during which the grant was obtained.

15. The apparatus of claim 14, wherein the first condition is satisfied when the BLER ratio is equal to or greater than a value.

16. The apparatus of claim 15, wherein the one or more processors, individually or in combination, are further configured to cause the apparatus to:
obtain, prior to outputting the first PDU, configuration information comprising an indication of the value.

17. The apparatus of claim 1, further comprising one or more transceivers configured to:
transmit, via the link, the signaling comprising the first PDU; and
transmit the reference signal, wherein the apparatus is configured as a user equipment (UE).

18. An apparatus for wireless communication, comprising:
one or more memories, individually or in combination, having instructions; and
one or more processors, individually or in combination, configured to execute the instructions and cause the apparatus to:
output, for transmission, signaling comprising an indication of a first condition associated with a first retransmission counter;
obtain, via a link, a reference signal indicative of satisfaction of the first condition; and
output, via the link and after the reference signal is obtained, signaling configured to initiate a handover process.

19. The apparatus of claim 18, wherein the signaling further comprises an indication of a second condition associated with a second retransmission counter.

20. The apparatus of claim 19, wherein at least one of:
satisfaction of the first condition is configured to cause a wireless node to transmit the reference signal,
satisfaction of the second condition is configured to cause the wireless node to perform radio link failure (RLF) recovery, or
the first condition is associated with a first threshold that is lower than a second threshold associated with the second condition.

21. The apparatus of claim 18, wherein the one or more processors, individually or in combination, are further configured to cause the apparatus to:
output additional signaling comprising a configuration associated with the reference signal.

22. The apparatus of claim 21, wherein the configuration associated with the reference signal comprises an indication of a sounding reference signal (SRS) to be used upon satisfaction of the first condition.

23. The apparatus of claim 18, wherein the indication of the first condition comprises and indication of at least one of: (i) a value of the first retransmission counter associated with whether the first condition is satisfied, or (ii) a block error rate (BLER) value associated with whether the first condition is satisfied.

24. The apparatus of claim 18, wherein the reference signal comprises a beacon signal or a sounding reference signal (SRS).

25. The apparatus of claim 24, wherein the beacon signal is a non-legacy reference signal.

26. The apparatus of claim 18, further comprising one or more transceivers configured to:
transmit the signaling comprising the indication of the first condition associated with the first retransmission counter;
receive the reference signal; and
transmit the signaling configured to initiate a handover process, wherein the apparatus is configured as a network entity.

27. A method for wireless communications at a wireless node, comprising:
outputting, for transmission via a link, signaling comprising a first protocol data unit (PDU); and
outputting, for transmission, a reference signal based on satisfaction of a first condition associated with a signal quality metric associated with the link.
